(19) United States
(12) Patent Application Publication
(10) Pub. No.: US 2009/0246325 A1
(43) Pub. Date: Oct. 1, 2009

(54) INSTANT NODDLES AND METHOD FOR PRODUCING INSTANT NODDLES

(76) Inventors: Toshitaka Yasuda, Kawasaki-shi (JP); Kohji Nakajima, Koshigata-shi (JP); Mika Takenouchi, Tokyo (JP); Motoki Mizuno, Yokohama-shi (JP); Junya Kanayama, Sagamihara-shi (JP); Kazuyoshi Masaki, Sakado-shi (JP); Akihiro Hanaoka, Chiba-shi (JP); Hiroyuki Minami, Yokohama-shi (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/308,904

(22) PCT Filed: Feb. 1, 2008
(86) PCT No.: PCT/JP2008/051669

§ 371 Date: Dec. 29, 2008

(30) Foreign Application Priority Data
Feb. 2, 2007 (JP) 2007-024601

(51) Int. Cl. A23L 1/162; A23L 1/337; A23P 1/10; A23P 1/08

(52) U.S. Cl. 426/89; 426/575; 426/465; 426/557; 426/451

(57) ABSTRACT

The present invention provides instant noodles containing agar and curdlan, having water absorption of 250% or more upon reconstitution with water at 20° C. for 3 minutes, and being capable of reconstitution with water in a time of 5 minutes or less, and having an excellent texture with suitable hardness.

### TECHNICAL FIELD

The present invention relates to instant noodles and a method for producing the instant noodles.

### BACKGROUND ART

When conventional instant noodles are to be eaten, noodle masses made of wheat flour, starch or buckwheat flour as a main raw material are packed in a container, for example, together with soup and other ingredients, and after pouring hot water thereto, the noodle masses are reconstituted with the hot water usually for 3 to 5 minutes before eating.

In such instant noodles, various modifiers are added for improving the texture, etc. of the noodles. For example, Jpn. Pat. Appln. KOKAI Publication No. 2-97361 describes that the texture of noodles produced in a usual manner from wheat flour or buckwheat flour as a main raw material can be improved by using thickening natural polysaccharides such as curdlan and guar gum as quality improvers in a part of starting materials to be added.

From the viewpoint of diversification and simplification of food, there has been demand for noodles eatable by reconstitution with water at room temperature (ordinary temperature) at about 20° C. in place of hot water. However, instant noodles that can be delectably eaten by reconstitution with water at room temperature in a short time of 3 to 5 minutes have not been known at all. For example, Jpn. Pat. Appln. KOKAI Publication No. 10-136949 describes a dried product of agar eatable by reconstitution with water, which is in a form shrunk amorphously by drying, under rotation or rolling, an agar gel that was cut in a suitable shape and size.

The dried product of agar described in Jpn. Pat. Appln. KOKAI Publication No. 10-136949 is, however, composed of agar, thus requiring considerable time on reconstitution with water, and has a very hard texture that is not suitable for eating upon reconstitution with water for 5 minutes or so.

### DISCLOSURE OF INVENTION

It is an object of the present invention to provide instant noodles being capable of reconstitution with water in a time of 5 minutes or less and having an excellent texture, and a method for producing the instant noodles.

According to a first aspect of the present invention, there is provided instant noodles comprising agar and curdlan and having water absorption of 250% or more upon reconstitution with water at 20° C. for 3 minutes.

According to a second aspect of the present invention, there is provided a method for producing instant noodles, comprising: preparing a sol of raw materials containing agar and curdlan, preparing gelatinized noodle strings from the sol, and drying the gelatinized noodle strings.

According to a third aspect of the present invention, there is provided instant noodles comprising carrageenin and curdlan and having water absorption of 300% or more upon reconstitution with water at 20° C. for 5 minutes.

According to a fourth aspect of the present invention, there is provided a method for producing instant noodles, comprising: preparing a sol of raw material containing carrageenin and curdlan, preparing gelatinized noodle strings from the sol, and drying the gelatinized noodle strings.

### BEST MODE FOR CARRYING OUT THE INVENTION

### First Embodiment

The instant noodles in a first embodiment contain agar and curdlan and have water absorption of 250% or more upon reconstitution with water at 20° C. for 3 minutes.

When instant noodles consist of the agar and the curdlan, the agar and the curdlan are compounded preferably in ratios of 1 to 90% by weight and 10 to 99% by weight, respectively. When the compounding ratio of the curdlan is lower than 10% by weight, the time for reconstitution with water may be prolonged and the noodles after reconstitution with water may have become hard. On the other hand, when the compounding ratio of the curdlan is higher than 99% by weight, the texture of the noodles after reconstitution with water may be deteriorated. The compounding ratios of the agar and the curdlan are more preferably 8 to 75% by weight and 25 to 92% by weight, respectively.

It is allowable that the instant noodles in the first embodiment are further compounded a third component of at least one selected from wheat flour and starch. Examples of wheat flour that can be used herein include strong wheat flour, medium wheat flour and weak wheat flour. These wheat flours may be used alone or as a mixture of two or more thereof. Examples of starches that can be used herein include potato starch, corn starch, wheat starch, and tapioca starch.

The third component is incorporated in a ratio of preferably 80% by weight or less, more preferably 70% by weight or less, based on the total amount of the agar and the curdlan. When the compounding ratio of the third component is higher than 80% by weight, water reconstitution in a short time (for example 3 minutes or so) becomes difficult.

The water absorption refers to a value (%) determined by using the equation: (w1/w0)×100 wherein w1 is the weight of noodles that are reconstituted with water and w0 is the weight of the noodles before reconstitution.

In the first embodiment, the water absorption (250% or more) of the instant noodles upon reconstitution with water at 20° C. for 3 minutes indicates a specific property of the instant noodles, and the water absorption of the instant noodles, even if the third component is contained in its compounding upper limit (i.e. 80% by weight), is 250% or more upon reconstitution with water at 20° C. for 3 minutes. However, when the instant noodles are composed of the agar and the curdlan, the water absorption thereof is preferably 400% or more upon reconstitution with water at 20° C. for 3 minutes.

It is allowable that the instant noodles in the first embodiment have a multilayer structure such as a 3-, 4- or 5-layer structure. The instant noodles having such a multilayer structure comprises outer layers contained the agar and the curdlan. An inner layer positioned between the outer layers has a composition different from that of the outer layers. Even in the instant noodles having such a multilayer structure, the water absorption thereof is 250% or more upon reconstitution with water at 20° C. for 3 minutes.

When the outer layer in the instant noodles of multilayer structure is composed of agar and curdlan, the agar and curdlan are incorporated preferably in ratios of 10 to 80% by weight and 20 to 90% by weight, respectively.

It is allowable that in the instant noodles of multilayer structure, the inner layer contains at least one component selected from agar and curdlan, or contains at least one component selected from polysaccharides and proteins. Particularly, the inner layer more preferably contains at least curdlan in consideration of water reconstitution.

It is allowable that in the instant noodles of multilayer structure, the outer layer and inner layer are further compounded respectively with at least one material as a third component selected from the above-mentioned wheat flour and starch.

The third component is incorporated preferably in a ratio of 80% by weight or less, more preferably 70% by weight or less, based on the total amount of the agar and the curdlan in the multilayer structure. When the compounding ratio of the third component is higher than 80% by weight, water reconstitution in a short time (for example 3 minutes or so) becomes difficult. The third component is incorporated preferably in a weight ratio of 0:100 to 80:20 in the outer layer:inner layer.

It is allowable that in the instant noodles in the first embodiment, various additives such as salts (e.g., sodium and potassium salts), amino acids, vitamins, and other food materials are added depending on the type of the noodles.

When the instant noodles in the first embodiment are to be eaten, the instant noodles may be reconstituted with water at 20° C. or less, for example cold water at about 4° C., without limitation to reconstitution with water at 20° C.

Hereinafter, a method for producing the instant noodles of a monolayer structure mentioned above will be described.

i) A sol of raw material containing agar and curdlan is prepared.

Specific preparation of the sol includes the following three methods:

(a) Agar is dispersed in water and dissolved by heating at 80 to 100° C. for example. A dispersion of curdlan in water is added to this heated aqueous solution of the agar while the temperature drops for example to 60° C., thereby preparing the sol.

(b) A dispersion of curdlan in water is heated for example from 40 to 60° C. In this heating process, the dispersion of the curdlan in water is converted into sol. When the temperature of this sol rises, for example, to 50° C., this temperature is maintained while a solution prepared by dissolving agar in heated water is added to the sol, to prepare the sol of raw material containing the agar and the curdlan.

(c) Agar is dispersed in water and dissolved by heating at 80 to 100° C., for example, and then gelatinized by cooling. The gel is milled to form the agar in sol form. This agar in sol form is added to a dispersion of curdlan in water, to prepare the sol of raw material containing the agar and the curdlan.

The total concentration of the agar and the curdlan in the sol is preferably 0.2 to 6.0% by weight. When the total concentration in the sol is lower than 0.2% by weight, gelatinizing, described later, may be difficult. On the other hand, when the total concentration in the sol is higher than 6.0% by weight, the resulting noodles may not be reconstituted with water in a short time (for example, about 3 minutes). The total concentration of the agar and the curdlan in the sol is more preferably 1.0 to 5.0% by weight.

The agar and the curdlan are compounded preferably in a weight ratio of from 1:99 to 90:10 in the sol, respectively. When the content ratio of the curdlan is lower than 10, the time for reconstituting the resulting instant noodles with water may be prolonged, and the noodles after reconstitution with water may become too hard. On the other hand, when the content ratio of the curdlan is higher than 99, the texture of the noodles after reconstitution with water may be deteriorated. The ratio of the agar and the curdlan is more preferably from 8:92 to 75:25 by weight.

It is allowable that a third component of at least one selected from wheat flour and starch is further contained in the sol. As the wheat flour, any of strong wheat flour, medium wheat flour and weak wheat flour for example may be used. These wheat flours may be used singly or as a mixture of two or more thereof. As the starch, any of potato starch, corn starch, wheat starch and tapioca starch for example may be used. The third component is incorporated in a ratio of preferably 80% by weight or less, more preferably 70% by weight or less, based on the total amount of the agar and the curdlan.

It is allowable that, depending on the type of instant noodles to be produced, various additives such as salts (e.g., sodium and potassium salts), amino acids, vitamins, and other food materials are further added to the sol.

ii) Gelled noodle strings are formed from the sol.

In preparation of gelatinized noodle strings from the sol, the following methods are used.

(1) The sol is spread on a plate made of glass or a metal such as stainless steel to form a sheet and then gelatinize by cooling the sheet to form a gelatinized noodle strip, and this gelatinized noodle strip is dried if necessary and then cut thin thereby preparing gelatinized noodle strings.

Cooling for gelatinizing is conducted for example at a temperature of preferably 20° C. or less, more preferably 0 to 10° C.

(2) The sol is spread on a plate made of glass or a metal such as stainless steel to form a sheet and then gelatinized by heating the sheet to form a gelatinized noodle strip, and this gelatinized noodle strip is dried if necessary and then cut thin thereby preparing gelatinized noodle strings.

For example, the heating temperature is preferably 80 to 100° C.

For the heating, a steaming method may be used. In the case of heating by steaming, it is preferable that the sol is applied in the form of a sheet on a metal mesh such as a stainless steel mesh, and the sheet-like sol on the mesh is heated by steaming the surface thereof and the backside of the mesh.

(3) The sol is discharged directly from a tube or nozzles to form thin strings and then gelatinized by cooling or heating the thin strings to form gelatinized noodle strings.

The cooling is conducted, for example, at a temperature of preferably 20° C. or less, more preferably 0 to 10° C. The heating is conducted preferably at 80 to 100° C. for example, and treatment with a steamer can be used.

iii) The gelatinized noodle strings are dried to produce instant noodles.

Specifically, the gelatinized noodle strings are dried and placed in a one-meal-size treatment container (for example, a retainer) and dried to prepare noodle masses. For example, the noodle masses are thereafter placed in a cup and sealed to produce cupped instant noodles. Other ingredients and soup are also packed in the cup.

As described above, the instant noodles in the first embodiment are characterized by comprising agar and curdlan and having water absorption of 250% or more upon reconstitution with water at 20° C. for 3 minutes. That is, the hard texture of noodles produced from the agar alone is improved and the long time of reconstitution thereof with water is reduced by incorporating curdlan having a property of being excellently reconstituted with water, so that there can be provided instant noodles being capable of reconstitution with water at 20° C. in a short time of 3 minutes and having an excellent texture with suitable hardness.

Particularly, the instant noodles being capable of reconstitution with water in a short time and having a more excellent texture can be obtained by comprising agar and curdlan incorporated in ratios of 1 to 90% by weight and 10 to 99% by weight, respectively.

According to the first embodiment, a sol of raw material containing agar and curdlan is prepared, and gelatinized noodle strings are prepared from this sol and then dried, whereby instant noodles being capable of reconstitution with water at 20° C. in a short time of 3 minutes and having an excellent texture with suitable hardness can be produced.

Instant noodles being capable of further shortening the time of constitution with water and having a more excellent texture can be produced by allowing the total concentration of the agar and the curdlan in the sol to be 0.2 to 6.0% by weight.

### Second Embodiment

The instant noodles in a second embodiment comprise carrageenin and curdlan and have water absorption of 300% or more upon reconstitution with water at 20° C. for 5 minutes.

As the carrageenin, κ-carrageenin for example can be used.

When instant noodles consist of carrageenin and curdlan, the carrageenin and the curdlan are compounded preferably in ratios of 2 to 98% by weight and 2 to 98% by weight, respectively. When the compounding ratio of the curdlan is lower than 2% by weight, the time for reconstitution with water may be prolonged and the noodles after reconstitution with water may become hard. On the other hand, when the compounding ratio of the curdlan is higher than 98% by weight, the texture of the noodles after reconstitution with water may be deteriorated. The compounding ratios of the carrageenin and the curdlan are 2 to 35% by weight and more preferably 65 to 98% by weight, respectively.

It is allowable that the instant noodles in the second embodiment, similar to those in the first embodiment, are further compounded a third component of at least one selected from wheat flour and starch. The third component is compounded preferably in a ratio of 60% by weight or less, more preferably 50% by weight or less, based on the total amount of the carrageenin and the curdlan. When the compounding ratio of the third component is higher than 60% by weight, gelatinizing may be difficult, the reconstitution of the resulting instant noodles with water may also be difficult, and the texture thereof may be deteriorated, particularly when wheat flour is used as the third component.

The water absorption (300% or more) of the instant noodles in the second embodiment upon reconstitution with water at 20° C. for 5 minutes indicates a specific property of the instant noodles, and the water absorption of the instant noodles, even if the third component is contained in its compounding upper limit (i.e. 60% by weight), is 300% or more upon reconstitution with water at 20° C. for 5 minutes. However, when the instant noodles consist of the carrageenin and the curdlan, the water absorption thereof is preferably 450% or more upon reconstitution with water at 20° C. for 5 minutes.

It is allowable that in the instant noodles in the second embodiment, various additives such as salts (e.g., sodium and potassium salts), amino acids, vitamins, and other food materials are further added depending on the type of the instant noodles.

When the instant noodles in the second embodiment are to be eaten, the instant noodles may be reconstituted with water at 20° C. or less, for example cold water at about 4° C., without limitation to reconstitution with water at 20° C.

Hereinafter, a method for producing the instant noodles described above will be explained.

i) A sol of raw material containing carrageenin and curdlan is prepared.

Specifically, the carrageenin and the curdlan are dispersed in water and heated, for example, at 40 to 50° C. to prepare a sol.

The total concentration of the carrageenin and the curdlan in the sol is preferably 1.2 to 7.2% by weight. When the total concentration in the sol is lower than 1.2% by weight, gelatinizing described later may be difficult. On the other hand, when the total concentration in the sol is higher than 7.2% by weight, the resulting instant noodles may not be reconstituted with water in a short time (for example about 5 minutes).

The Carrageenin and the curdlan are compounded preferably in a weight ratio of from 2:98 to 98:2. When the content ratio of the curdlan is lower than 2, the time for reconstituting the resulting instant noodles with water may be prolonged, and the noodles after reconstitution with water may become too hard. On the other hand, when the content ratio of the curdlan is higher than 98, the texture of the noodles after reconstitution with water may be deteriorated.

It is allowable that a third component of at least one selected from wheat flour and starch is further contained in the sol similar to that in the first embodiment described above. The third component is incorporated in a ratio of preferably 60% by weight or less, more preferably 50% by weight or less, based on the total amount of the carrageenin and the curdlan.

It is allowable that, depending on the type of instant noodles to be produced, various additives such as salts (e.g., sodium and potassium salts), amino acids, vitamins, and other food materials are further added to the sol.

ii) Gelled noodle strings are formed from the sol.

In preparation of gelatinized noodle strings from the sol, the following methods are used.

(1) The sol is spread on a plate made of glass or a metal such as stainless steel to form a sheet and then gelatinize by cooling the sheet to form a gelatinized noodle strip, and this gelatinized noodle strip is dried if necessary and then cut thin, thereby preparing gelatinized noodle strings.

Cooling for gelatinizing is conducted, for example, at a temperature of preferably 20° C. or less, more preferably 0 to 10° C.

(2) The sol is spread on a plate made of glass or a metal such as stainless steel to form a sheet and then gelatinize by heating the sheet to form a gelatinized noodle strip, and this gelatinized noodle strip is dried if necessary and then cut thin, thereby preparing gelatinized noodle strings.

For example, the heating temperature is preferably 80 to 100° C.

For heating, a steaming method may be used. In the case of heating by steaming, it is preferable that the sol is applied in the form of a sheet on a metal mesh such as a stainless steel mesh, and the sheet-like sol on the mesh is heated by steaming the surface thereof and the backside of the mesh.

(3) The sol is discharged directly from a tube or nozzles to form thin strings and then gelatinize by cooling or heating the thin strings to form gelatinized noodle strings.

Cooling is conducted for example at a temperature of preferably 20° C. or less, more preferably 0 to 10° C. Heating is conducted preferably at 80 to 100° C. for example, and treatment with a steamer can be used.

When the method of gelatinizing by cooling is used, the total concentration of the carrageenin and the curdlan in the sol is preferably 1.2 to 5.2% by weight, more preferably 1.5 to 5.0% by weight. At this time, the carrageenin and the curdlan in the sol are contained preferably in a weight ratio of from 2:98 to 98:2, more preferably in a weight ratio of from 2:98 to 35:65.

When the method of gelatinizing by heating is used, the total concentration of the carrageenin and the curdlan in the sol is preferably 2.2 to 7.2% by weight, more preferably 2.2 to 5.2% by weight. At this time, the carrageenin and the curdlan in the sol are compounded preferably in a weight ratio of from 2:98 to 98:2, more preferably in a weight ratio of from 2:98 to 35:65.

iii) The gelatinized noodle strings are dried to produce instant noodles.

Specifically, the gelatinized noodle strings are dried and placed in a one-meal-size treatment container (for example a retainer) and dried to prepare noodle masses. For example, the noodle masses are thereafter placed in a cup and sealed to produce cupped instant noodles. Other ingredients and soup are also packed in the cup.

As described above, the instant noodles in the second embodiment are characterized by comprising carrageenin and curdlan and having water absorption of 300% or more upon reconstitution with water at 20° C. for 5 minutes. That is, there can be provided instant noodles which, due to the interaction between the carrageenin and the curdlan, can be reconstituted with water at 20° C. in a short time of 5 minutes and have an excellent texture with suitable hardness.

Particularly, the instant noodles being capable of reconstitution with water in a short time and having a more excellent texture can be obtained by incorporating carrageenin and curdlan in ratios of 2 to 98% by weight and 2 to 98% by weight, respectively.

According to the second embodiment, a sol of raw material containing carrageenin and curdlan is prepared, and gelatinized noodle strings are prepared from this sol and then dried, whereby instant noodles being capable of reconstitution with water at 20° C. in a short time of 5 minutes and having an excellent texture with suitable hardness can be produced.

Particularly, when the sol is gelatinized by cooling such as in the method (1) above in preparation of gelatinized noodle strings, instant noodles being capable of reconstitution with water in a short time of 5 minutes and having a more excellent texture, due to the excellent water reconstitution of curdlan, can be produced by incorporating the carrageenin and the curdlan wherein the total concentration of the carrageenin and the curdlan in the sol is 1.2 to 5.2% by weight and simultaneously the weight ratio of carrageenin:curdlan in the sol is in a weight ratio of from 2:98 to 98:2.

When the sol is gelatinized by heating (for example, steaming) such as in the method (2) above in preparation of gelatinized noodle strings, instant noodles being capable of reconstitution with water in a short time (for example 5, minutes or so) and having a more excellent texture, due to the interaction between the carrageenin and the curdlan, can be produced by incorporating the carrageenin and the curdlan wherein the total concentration of the carrageenin and the curdlan in the sol is 2.2 to 7.2% by weight and simultaneously the weight ratio of the carrageenin the curdlan is in a weight ratio of from 2:98 to 98:2.

Hereinafter, Examples of the present invention will be described in detail. In the following Examples and Comparative Examples, the sol concentration value is shown by being rounded off the number to the first decimal place, and the water absorption is shown by being rounded off to the nearest one. The weight ratio of agar and curdlan in Tables 1 and 3 and the weight ratio of carrageenin and curdlan in Tables 2 and 4 are shown by being rounded to the integer decimal place, if those ratio values have only figures after decimal point.

### Example 1

1.5 g of agar (trade name: UM-11KS, manufactured by Ina Food Industry Co., Ltd.) was dispersed in 80 mL of water and dissolved by heating at 100° C. 20 mL of water containing 0.5 g of curdlan (trade name: Curdlan NS, manufactured by Kirin Food-Tech Company, Limited) dispersed therein was added to the heated aqueous agar solution, followed by dropping the temperature to 60° C. under stirring, thereby preparing a sol containing agar and curdlan at a total concentration of 2.0% by weight. Then, this sol was applied to a thickness of 1.5 mm on a glass plate and gelatinized by leaving this glass plate on ice water for 5 minutes to form a sheet-like gel. This sheet-like gel was stripped off from the glass plate and cut thinly into pieces of 2 mm in width to prepare noodle strings. These noodle strings were dried by blowing a hot-air of 90° C. on the noodle strings for 8 minutes, then placed in a retainer and dried by blowing a hot-air of 90° C. on the noodle strings for 25 minutes to give noodle masses.

The resulting noodle masses were reconstituted with water at 20° C. for 3 minutes. At this time, the noodle masses changed their weight from 0.90 g before reconstitution with water to 7.34 g, to show 820% water absorption.

### Example 2

1.8 g of agar (trade name: UM-11KS, manufactured by Ina Food Industry Co., Ltd.) was dispersed in 80 mL of water and dissolved by heating at 100° C. 20 mL of water containing 0.2 g of curdlan (trade name: Curdlan NS, manufactured by Kirin Food-Tech Company, Limited) dispersed therein was added to the heated aqueous agar solution, followed by dropping the temperature to 60° C. under stirring, thereby preparing a sol containing agar and curdlan at a total concentration of 2.0% by weight. Then, this sol was applied to a thickness of 1.5 mm on a glass plate and gelatinized by leaving this glass plate on ice water for 5 minutes to form a sheet-like gel. This sheet-like gel was stripped off from the glass plate and cut thinly into pieces of 2 mm in width to prepare noodle strings. These noodle strings were dried at 90° C. for 8 minutes, then placed in a retainer and dried by blowing a hot-air of 90° C. on the noodle strings for 25 minutes to give noodle masses.

The resulting noodle masses were reconstituted with water at 20° C. for 3 minutes. At this time, the noodle masses changed their weight from 0.94 g before reconstitution with water to 7.44 g, to show 790% water absorption.

### Example 3

1.0 g of agar (trade name: UM-11KS, manufactured by Ina Food Industry Co., Ltd.) was dispersed in 80 mL of water and dissolved by heating at 100° C. 20 mL of water containing 1.0 g of curdlan (trade name: Curdlan NS, manufactured by Kirin Food-Tech Company, Limited) dispersed therein was added to the heated aqueous agar solution, followed by dropping the temperature to 60° C. under stirring, thereby preparing a sol containing agar and curdlan at a total concentration of 2.0% by weight. Then, this sol was applied to a thickness of 1.5 mm on a glass plate and gelatinized by leaving this glass plate on ice water for 5 minutes to form a sheet-like gel. This sheet-like gel was stripped off from the glass plate and cut thinly into pieces of 2 mm in width to prepare noodle strings. These noodle strings were dried at 90° C. for 8 minutes, then placed in a retainer and dried by blowing a hot-air of 90° C. on the noodle strings for 25 minutes to give noodle masses.

The resulting noodle masses were reconstituted with water at 20° C. for 3 minutes. At this time, the noodle masses changed their weight from 1.01 g before reconstitution with water to 7.87 g, to show 780% water absorption.

### Example 4

0.2 g of agar (trade name: UM-11KS, manufactured by Ina Food Industry Co., Ltd.) was dispersed in 60 mL of water and dissolved by heating at 100° C. 40 mL of water containing 1.8 g of curdlan (trade name: Curdlan NS, manufactured by Kirin Food-Tech Company, Limited) dispersed therein was added to the heated aqueous agar solution, followed by dropping the temperature to 60° C. under stirring, thereby preparing a sol containing agar and curdlan at a total concentration of 2.0% by weight. Then, this sol was applied to a thickness of 1.5 mm on a glass plate and gelatinized by leaving this glass plate on ice water for 5 minutes to form a sheet-like gel. This sheet-like gel was stripped off from the glass plate and cut thinly into pieces of 2 mm in width to prepare noodle strings. These noodle strings were dried at 90° C. for 8 minutes, then placed in a retainer and dried by blowing a hot-air of 90° C. on the noodle strings for 25 minutes to give noodle masses.

The resulting noodle masses were reconstituted with water at 20° C. for 3 minutes. At this time, the noodle masses changed their weight from 0.89 g before reconstitution with water to 7.47 g, to show 840% water absorption.

### Example 5

0.38 g of agar (trade name: UM-11KS, manufactured by Ina Food Industry Co., Ltd.) was dispersed in 80 mL of water and dissolved by heating at 100° C. 20 mL of water containing 0.13 g of curdlan (trade name: Curdlan NS, manufactured by Kirin Food-Tech Company, Limited) dispersed therein was added to the heated aqueous agar solution, followed by dropping the temperature to 60° C. under stirring, thereby preparing a sol containing agar and curdlan at a total concentration of 0.5% by weight. Then, this sol was applied to a thickness of 1.5 mm on a glass plate and gelatinized by leaving this glass plate on ice water for 5 minutes to form a sheet-like gel. This sheet-like gel was stripped off from the glass plate and cut thinly into pieces of 2 mm in width to prepare noodle strings. These noodle strings were dried at 90° C. for 8 minutes, then placed in a retainer and dried by blowing a hot-air of 90° C. on the noodle strings for 25 minutes to give noodle masses.

The resulting noodle masses were reconstituted with water at 20° C. for 3 minutes. At this time, the noodle masses changed their weight from 0.32 g before reconstitution with water to 4.03 g, to show 1260% water absorption.

### Example 6

0.75 g of agar (trade name: UM-11KS, manufactured by Ina Food Industry Co., Ltd.) was dispersed in 80 mL of water and dissolved by heating at 100° C. 20 mL of water containing 0.25 g of curdlan (trade name: Curdlan NS, manufactured by Kirin Food-Tech Company, Limited) dispersed therein was added to the heated aqueous agar solution, followed by dropping the temperature to 60° C. under stirring, thereby preparing a sol containing agar and curdlan at a total concentration of 1.0% by weight. Then, this sol was applied to a thickness of 1.5 mm on a glass plate and gelatinized by leaving this glass plate on ice water for 5 minutes to form a sheet-like gel. This sheet-like gel was stripped off from the glass plate and cut thinly into pieces of 2 mm in width to prepare noodle strings. These noodle strings were dried at 90° C. for 8 minutes, then placed in a retainer and dried by blowing a hot-air of 90° C. on the noodle strings for 25 minutes to give noodle masses.

The resulting noodle masses were reconstituted with water at 20° C. for 3 minutes. At this time, the noodle masses changed their weight from 0.45 g before reconstitution with water to 5.63 g, to show 1250% water absorption.

### Example 7

1.13 g of agar (trade name: UM-11KS, manufactured by Ina Food Industry Co., Ltd.) was dispersed in 80 mL of water and dissolved by heating at 100° C. 20 mL of water containing 0.38 g of curdlan (trade name: Curdlan NS, manufactured by Kirin Food-Tech Company, Limited) dispersed therein was added to the heated aqueous agar solution, followed by dropping the temperature to 60° C. under stirring, thereby preparing a sol containing agar and curdlan at a total concentration of 1.5% by weight. Then, this sol was applied to a thickness of 1.5 mm on a glass plate and gelatinized by leaving this glass plate on ice water for 5 minutes to form a sheet-like gel. This sheet-like gel was stripped off from the e glass plate and cut thinly into pieces of 2 mm in width to prepare noodle strings. These noodle strings were dried at 90° C. for 8 minutes, then placed in a retainer and dried by blowing a hot-air of 90° C. on the noodle strings for 25 minutes to give noodle masses.

The resulting noodle masses were reconstituted with water at 20° C. for 3 minutes. At this time, the noodle masses changed their weight from 0.50 g before reconstitution with water to 5.83 g, to show 1170% water absorption.

### Example 8

0.27 g of agar (trade name: UM-11KS, manufactured by Ina Food Industry Co., Ltd.) was dispersed in 80 mL of water and dissolved by heating at 100° C. 20 mL of water containing 0.03 g of curdlan (trade name: Curdlan NS, manufactured by Kirin Food-Tech Company, Limited) dispersed therein was added to the heated aqueous agar solution, followed by dropping the temperature to 60° C. under stirring, thereby preparing a sol containing agar and curdlan at a total concentration of 0.3% by weight. Then, this sol was applied to a thickness of 1.5 mm on a glass plate and gelatinized by leaving this glass plate on ice water for 5 minutes to form a sheet-like gel. This sheet-like gel was stripped off from the glass plate and cut thinly into pieces of 2 mm in width to prepare noodle strings. These noodle strings were dried at 90° C. for 8 minutes, then placed in a retainer and dried by blowing a hot-air of 90° C. on the noodle strings for 25 minutes to give noodle masses.

The resulting noodle masses were reconstituted with water at 20° C. for 3 minutes. At this time, the noodle masses changed their weight from 0.29 g before reconstitution with water to 2.73 g, to show 940% water absorption.

### Example 9

4.5 g of curdlan (trade name: Curdlan NS, manufactured by Kirin Food-Tech Company, Limited) was dispersed in 80 mL of water and dissolved by heating to 60° C. to form curdlan sol. An aqueous agar solution kept at 60° C. prepared by dissolving 0.5 g of agar (trade name: UM-11KS, manufactured by Ina Food Industry Co., Ltd.) under heating in 20 mL of water was added to the sol, thereby preparing a sol containing agar and curdlan at a total concentration of 4.8% by weight. Then, this sol was applied to a thickness of 1.5 mm on a glass plate and gelatinized by leaving this glass plate on ice water for 5 minutes to form a sheet-like gel. This sheet-like gel was stripped off from the glass plate and cut thinly into pieces of 2 mm in width to prepare noodle strings. These noodle strings were dried at 90° C. for 8 minutes, then placed in a retainer and dried by blowing a hot-air of 90° C. on the noodle strings for 25 minutes to give noodle masses.

The resulting noodle masses were reconstituted with water at 20° C. for 3 minutes. At this time, the noodle masses changed their weight from 3.16 g before reconstitution with water to 14.30 g, to show 450% water absorption.

### Example 10

5.4 g of curdlan (trade name: Curdlan NS, manufactured by Kirin Food-Tech Company, Limited) was dispersed in 90 mL of water and dissolved by heating to 60° C. to form curdlan sol. An aqueous agar solution kept at 60° C. prepared by dissolving 0.6 g of agar (trade name: UM-11KS, manufactured by Ina Food Industry Co., Ltd.) under heating in 20 mL of water was added to the sol, thereby preparing a sol containing agar and curdlan at a total concentration of 5.7% by weight. Then, this sol was applied to a thickness of 1.5 mm on a glass plate and gelatinized by leaving this glass plate on ice water for 5 minutes to form a sheet-like gel. This sheet-like gel was stripped off from the glass plate and cut thinly into pieces of 2 mm in width to prepare noodle strings. These noodle strings were dried at 90° C. for 8 minutes, then placed in a retainer and dried by blowing a hot-air of 90° C. on the noodle strings for 25 minutes to give noodle masses.

The resulting noodle masses were reconstituted with water at 20° C. for 3 minutes. At this time, the noodle masses changed their weight from 2.84 g before reconstitution with water to 12.89 g, to show 450% water absorption.

### Example 11

0.3 g of agar (trade name: Ina Kanten Yamato, manufactured by Ina Food Industry Co., Ltd.) was dispersed in 70 mL of water, dissolved on a boiling water bath, and then cooled to about 50° C. 3.3 g of curdlan (trade name: Curdlan NS, manufactured by Kirin Food-Tech Company, Limited) was dispersed in the agar solution and then heated to 50° C., to prepare a sol containing agar and curdlan at a total concentration of 4.9% by weight. Then, this sol was applied to a thickness of 1.5 mm on a 100-mesh stainless steel mesh and gelatinized by steaming for 5 minutes to form a gel. This gel was cut thinly into pieces of 2.0 mm in width to prepare noodle strings. These noodle strings were dried at 90° C. for 13 minutes, then placed in a retainer and dried by blowing a hot-air of 90° C. on the noodle strings for 20 minutes to give noodle masses.

The resulting noodle masses were reconstituted with water at 20° C. for 3 minutes. At this time, the noodle masses changed their weight from 1.73 g before reconstitution with water to 9.70 g, to show 560% water absorption.

### Example 12

0.05 g of agar (trade name: Ina Kanten Yamato, manufactured by Ina Food Industry Co., Ltd.) was dispersed in 70 mL of water, dissolved on a boiling water bath, and then cooled to about 50° C. 3.3 g of curdlan (trade name: Curdlan NS, manufactured by Kirin Food-Tech Company, Limited) was dispersed in the agar solution and then heated to 50° C. to prepare a sol containing agar and curdlan at a total concentration of 4.6% by weight. Then, this sol was applied to a thickness of 1.5 mm on a 100-mesh stainless steel mesh and gelatinized by steaming for 5 minutes to form a gel. This gel was cut thinly into pieces of 2.0 mm in width to prepare noodle strings. These noodle strings were dried at 90° C. for 13 minutes, then placed in a retainer and dried by blowing a hot-air of 90° C. on the noodle strings for 20 minutes to give noodle masses.

The resulting noodle masses were reconstituted with water at 20° C. for 3 minutes. At this time, the noodle masses changed their weight from 2.28 g before reconstitution with water to 9.71 g, to show 430% water absorption.

### Example 13

0.75 g of agar (trade name: Ina Kanten Yamato, manufactured by Ina Food Industry Co., Ltd.) was dispersed in 70 mL of water, dissolved on a boiling water bath, and then cooled to about 50° C. 3.3 g of curdlan (trade name: Curdlan NS, manufactured by Kirin Food-Tech Company, Limited) was dispersed in the agar solution and then heated to 50° C. to prepare a sol containing agar and curdlan at a total concentration of 5.5% by weight. Then, this sol was applied to a thickness of 1.5 mm on a 100-mesh stainless steel mesh and gelatinized by steaming for 5 minutes to form a gel. This gel was cut thinly into pieces of 2.0 mm in width to prepare noodle strings. These noodle strings were dried at 90° C. for 13 minutes, then placed in a retainer and dried by blowing a hot-air of 90° C. on the noodle strings for 20 minutes to give noodle masses.

The resulting noodle masses were reconstituted with water at 20° C. for 3 minutes. At this time, the noodle masses changed their weight from 1.65 g before reconstitution with water to 7.79 g, to show 470% water absorption.

### Comparative Example 1

2.0 g of agar (trade name: UM-11KS, manufactured by Ina Food Industry Co., Ltd.) was dispersed in 100 mL of water and dissolved by heating at 100° C. After dissolution, the temperature of the solution was decreased to 60° C. under stirring, to prepare a sol. Then, this sol was applied to a thickness of 1.5 mm on a glass plate and gelatinized by leaving this glass plate on ice water for 5 minutes to form a sheet-like gel. This sheet-like gel was stripped off from the glass plate and cut thinly into pieces of 2.0 mm in width to prepare noodle strings. These noodle strings were dried at 90° C. for 8 minutes, then placed in a retainer and dried by blowing a hot-air of 90° C. on the noodle strings for 25 minutes to give noodle masses.

The resulting noodle masses were reconstituted with water at 20° C. for 3 minutes. At this time, the noodle masses changed their weight from 0.84 g before reconstitution with water to 5.81 g, to show 690% water absorption.

### Comparative Example 2

60 mL of water was heated to 100° C., and 40 mL of water containing 2.0 g of curdlan (trade name: Curdlan NS, manufactured by Kirin Food-Tech Company, Limited) dispersed therein was added thereto, followed by decreasing the temperate to 60° C. under stirring, to prepare a sol. Then, this sol was applied to a thickness of 1.5 mm on a glass plate and gelatinized by leaving this glass plate on ice water for 5 minutes to form a sheet-like gel. This sheet-like gel was stripped off from the glass plate and cut thinly into pieces of 2.0 mm in width to prepare noodle strings. These noodle strings were dried at 90° C. for 8 minutes, then placed in a retainer and dried by blowing a hot-air of 90° C. on the noodle strings for 25 minutes to give noodle masses.

The resulting noodle masses were reconstituted with water at 20° C. for 3 minutes. At this time, the noodle masses changed their weight from 0.87 g before reconstitution with water to 7.12 g, to show 820% water absorption.

After 200 mL of water at 20° C. was poured onto each of noodle mass obtained in Examples 1 to 13 and Comparative Examples 1 and 2, the noodle masses were reconstituted with water for exactly 3 minutes, then eaten by a panel of 7 judges, thereby comprehensively evaluating their texture, hardness, feeling upon swallowing, and taste, and finally judged as “A” (very good), “B” (good) or “C” (bad). The results are shown in Table 1 below. In Table 1, the raw material composition, sol concentration and water absorption are shown.

TABLE 1

| | Raw material | | Sol | | Compre- |
|---|---|---|---|---|---|
| | composition | | concen- | Water | hensive |
| | (weight ratio) | | tration | absorp- | evalua- |
| | Agar | Curdlan | (wt %) | tion (%) | tion |
| Example 1 | 75 | 25 | 2.0 | 820 | B |
| Example 2 | 90 | 10 | 2.0 | 790 | B |
| Example 3 | 50 | 50 | 2.0 | 780 | A |
| Example 4 | 10 | 90 | 2.0 | 840 | A |
| Example 5 | 75 | 25 | 0.5 | 1260 | B |
| Example 6 | 75 | 25 | 1.0 | 1250 | A |
| Example 7 | 75 | 25 | 1.5 | 1170 | A |
| Example 8 | 90 | 10 | 0.3 | 940 | B |
| Example 9 | 10 | 90 | 4.8 | 450 | A |
| Example 10 | 10 | 90 | 5.7 | 450 | B |
| Example 11 | 8 | 92 | 4.9 | 560 | A |
| Example 12 | 1 | 99 | 4.6 | 430 | B |
| Example 13 | 19 | 81 | 5.5 | 470 | B |
| Comparative | 100 | — | 2.0 | 690 | C |
| Example 1 | | | | | |
| Comparative | — | 100 | 2.0 | 820 | C |
| Example 2 | | | | | |

As is evident from Table 1 above, it can be seen that the instant noodles consisting of agar and curdlan in Examples 1 to 13 can be reconstituted in 3 minutes with water at 20° C. and are excellent in comprehensive evaluation in eating after reconstitution with water, as compared with those in Comparative Examples 1 and 2. That is, it was revealed that instant noodles that can be eaten after a short time of 3 minutes and are excellent in texture and taste, which cannot be achieved by singly using agar or curdlan, can be produced by combination of agar and curdlan as shown in the present invention.

### Example 14

0.1 g of carrageenin (trade name: Purified Carrageenan, manufactured by CP Kelco) and 3.3 g of curdlan (trade name: Curdlan NS, manufactured by Kirin Food-Tech Company, Limited) were dispersed in 70 mL of water and then heated to 50° C., thereby preparing a sol containing carrageenin and curdlan at a total concentration of 4.6% by weight. This sol was applied to a thickness of 1.5 mm on a 100-mesh stainless steel mesh and gelatinized by steaming for 5 minutes to form a sheet-like gel. Then, this sheet-like gel was stripped off from the stainless steel mesh and then cut thinly into pieces of 6.5 mm in width to prepare noodle strings. These noodle strings were dried at 90° C. for 13 minutes, then placed in a retainer and dried by blowing a hot-air of 90° C. on the noodle strings for 20 minutes to give noodle masses.

The resulting noodle masses were reconstituted with water at 20° C. for 5 minutes. At this time, the noodle masses changed their weight from 3.55 g before reconstitution with water to 17.12 g, to show 480% water absorption.

### Example 15

0.1 g of carrageenin (trade name: Purified Carrageenan, manufactured by CP Kelco) and 3.3 g of curdlan (trade name: Curdlan NS, manufactured by Kirin Food-Tech Company, Limited) were dispersed in 150 mL of water and then heated to 60° C., thereby preparing a sol containing carrageenin and curdlan at a total concentration of 2.2% by weight. This sol was applied to a thickness of 1.5 mm on a 100-mesh stainless steel mesh and gelatinized by steaming for 5 minutes to form a sheet-like gel. Then, this sheet-like gel was stripped off from the stainless steel mesh and then cut thinly into pieces of 6.5 mm in width to prepare noodle strings. These noodle strings were dried at 90° C. for 13 minutes, then placed in a retainer and dried by blowing a hot-air of 90° C. on the noodle strings for 20 minutes to give noodle masses.

The resulting noodle masses were reconstituted with water at 20° C. for 5 minutes. At this time, the noodle masses changed their weight from 1.8 g before reconstitution with water to 13.87 g, to show 770% water absorption.

### Example 16

0.54 g of carrageenin (trade name: Purified Carrageenan, manufactured by CP Kelco) and 3.3 g of curdlan (trade name: Curdlan NS, manufactured by Kirin Food-Tech Company, Limited) were dispersed in 50 mL of water and then heated to 50° C., thereby preparing a sol containing carrageenin and curdlan at a total concentration of 7.1% by weight. This sol was applied to a thickness of 1.5 mm on a 100-mesh stainless steel mesh and gelatinized by steaming for 5 minutes to form a sheet-like gel. Then, this sheet-like gel was stripped off from the stainless steel mesh and then cut thinly into pieces of 6.5 mm in width to prepare noodle strings. These noodle strings were dried at 90° C. for 13 minutes, then placed in a retainer and dried by blowing a hot-air of 90° C. on the noodle strings for 20 minutes to give noodle masses.

The resulting noodle masses were reconstituted with water at 20° C. for 5 minutes. At this time, the noodle masses changed their weight from 4.63 g before reconstitution with water to 29.97 g, to show 650% water absorption.

### Example 17

0.54 g of carrageenin (trade name: Purified Carrageenan, manufactured by CP Kelco) and 3.3 g of curdlan (trade name: Curdlan NS, manufactured by Kirin Food-Tech Company, Limited) were dispersed in 70 mL of water and then-heated to 50° C., thereby preparing a sol containing carrageenin and curdlan at a total concentration of 5.2% by weight. This sol was applied to a thickness of 1.5 mm on a 100-mesh stainless steel mesh and gelatinized by steaming for 5 minutes to form a sheet-like gel. Then, this sheet-like gel was stripped off from the stainless steel mesh and then cut thinly into pieces of 6.5 mm in width to prepare noodle strings. These noodle strings were dried at 90° C. for 13 minutes, then placed in a retainer and dried by blowing a hot-air of 90° C. on the noodle strings for 20 minutes to give noodle masses.

The resulting noodle masses were reconstituted with water at 20° C. for 5 minutes. At this time, the noodle masses changed their weight from 4.16 g before reconstitution with water to 25.05 g, to show 600% water absorption.

### Example 18

0.54 g of carrageenin (trade name: Purified Carrageenan, manufactured by CP Kelco) and 3.3 g of curdlan (trade name: Curdlan NS, manufactured by Kirin Food-Tech Company, Limited) were dispersed in 150 mL of water and then heated to 50° C., thereby preparing a sol containing carrageenin and curdlan at a total concentration of 2.5% by weight. This sol was applied to a thickness of 1.5 mm on a 100-mesh stainless steel mesh and gelatinized by steaming for 5 minutes to form a sheet-like gel. Then, this sheet-like gel was stripped off from the stainless steel mesh and then cut thinly into pieces of 6.5 mm in width to prepare noodle strings. These noodle strings were dried at 90° C. for 13 minutes, then placed in a retainer and dried by blowing a hot-air of 90° C. on the noodle strings for 20 minutes to give noodle masses.

The resulting noodle masses were reconstituted with water at 20° C. for 5 minutes. At this time, the noodle masses changed their weight from 2.20 g before reconstitution with water to 25.33 g, to show 1150% water absorption.

### Example 19

1.2 g of carrageenin (trade name: Purified Carrageenan, manufactured by CP Kelco) and 2.64 g of curdlan (trade name: Curdlan NS, manufactured by Kirin Food-Tech Company, Limited) were dispersed in 70 mL of water and then heated to 50° C., thereby preparing a sol containing carrageenin and curdlan at a total concentration of 5.2% by weight. This sol was applied to a thickness of 1.5 mm on a 100-mesh stainless steel mesh and gelatinized by steaming for 5 minutes to form a sheet-like gel. Then, this sheet-like gel was stripped off from the stainless steel mesh and then cut thinly into pieces of 6.5 mm in width to prepare noodle strings. These noodle strings were dried at 90° C. for 13 minutes, then placed in a retainer and dried by blowing a hot-air of 90° C. on the noodle strings for 20 minutes to give noodle masses.

The resulting noodle masses were reconstituted with water at 20° C. for 5 minutes. At this time, the noodle masses changed their weight from 3.65 g before reconstitution with water to 25.85 g, to show 710% water absorption.

### Example 20

1.34 g of carrageenin (trade name: Purified Carrageenan, manufactured by CP Kelco) and 2.5 g of curdlan (trade name: Curdlan NS, manufactured by Kirin Food-Tech Company, Limited) were dispersed in 70 mL of water and then heated to 50° C., thereby preparing a sol containing carrageenin and curdlan at a total concentration of 5.2% by weight. This sol was applied to a thickness of 1.5 mm on a 100-mesh stainless steel mesh and gelatinized by steaming for 5 minutes to form a sheet-like gel. Then, this sheet-like gel was stripped off from the stainless steel mesh and then cut thinly into pieces of 6.5 mm in width to prepare noodle strings. These noodle strings were dried at 90° C. for 13 minutes, then placed in a retainer and dried by blowing a hot-air of 90° C. on the noodle strings for 20 minutes to give noodle masses.

The resulting noodle masses were reconstituted with water at 20° C. for 5 minutes. At this time, the noodle masses changed their weight from 4.37 g before reconstitution with water to 24.52 g, to show 560% water absorption.

### Example 21

1.5 g of carrageenin (trade name: Purified Carrageenan, manufactured by CP Kelco) and 2.34 g of curdlan (trade name: Curdlan NS, manufactured by Kirin Food-Tech Company, Limited) were dispersed in 70 mL of water and then heated to 50° C., thereby preparing a sol containing carrageenin and curdlan at a total concentration of 5.2% by weight. This sol was applied to a thickness of 1.5 mm on a 100-mesh stainless steel mesh and gelatinized by steaming for 5 minutes to form a sheet-like gel. Then, this sheet-like gel was stripped off from the stainless steel mesh and then cut thinly into pieces of 6.5 mm in width to prepare noodle strings. These noodle strings were dried at 90° C. for 13 minutes, then placed in a retainer and dried by blowing a hot-air of 90° C. on the noodle strings for 20 minutes to give noodle masses.

The resulting noodle masses were reconstituted with water at 20° C. for 5 minutes. At this time, the noodle masses changed their weight from 3.65 g before reconstitution with water to 28.55 g, to show 780% water absorption.

### Example 22

2.84 g of carrageenin (trade name: Purified Carrageenan, manufactured by CP Kelco) and 1.0 g of curdlan (trade name: Curdlan NS, manufactured by Kirin Food-Tech Company, Limited) were dispersed in 70 mL of water and then heated to 70° C., thereby preparing a sol containing carrageenin and curdlan at a total concentration of 5.2% by weight. This sol was applied to a thickness of 1.5 mm on a 100-mesh stainless steel mesh and gelatinized by steaming for 5 minutes to form a sheet-like gel. Then, this sheet-like gel was stripped off from the stainless steel mesh and then cut thinly into pieces of 6.5 mm in width to prepare noodle strings. These noodle strings were dried at 90° C. for 13 minutes, then placed in a retainer and dried by blowing a hot-air of 90° C. on the noodle strings for 20 minutes to give noodle masses.

The resulting noodle masses were reconstituted with water at 20° C. for 5 minutes. At this time, the noodle masses changed their weight from 3.56 g before reconstitution with water to 34.81 g, to show 980% water absorption.

### Example 23

3.74 g of carrageenin (trade name: Purified Carrageenan, manufactured by CP Kelco) and 0.1 g of curdlan (trade name: Curdlan NS, manufactured by Kirin Food-Tech Company, Limited) were dispersed in 70 mL of water and then heated to 70° C., thereby preparing a sol containing carrageenin and curdlan at a total concentration of 5.2% by weight. This sol was applied to a thickness of 1.5 mm on a 100-mesh stainless steel mesh and gelatinized by steaming for 5 minutes to form a sheet-like gel. Then, this sheet-like gel was stripped off from the stainless steel mesh and then cut thinly into pieces of 6.5 mm in width to prepare noodle strings. These noodle strings were dried at 90° C. for 13 minutes, then placed in a retainer and dried by blowing a hot-air of 90° C. on the noodle strings for 20 minutes to give noodle masses.

The resulting noodle masses were reconstituted with water at 20° C. for 5 minutes. At this time, the noodle masses changed their weight from 2.59 g before reconstitution with water to 35.57 g, to show 1330% water absorption.

### Example 24

3.74 g of carrageenin (trade name: Purified Carrageenan, manufactured by CP Kelco) and 0.1 g of curdlan (trade name: Curdlan NS, manufactured by Kirin Food-Tech Company, Limited) were dispersed in 250 mL of water and then heated to 70° C., thereby preparing a sol containing carrageenin and curdlan at a total concentration of 1.5% by weight. This sol was applied to a thickness of 1.5 mm on a stainless steel plate and gelatinized by cooling at 5° C. for 10 minutes to form a sheet-like gel. Then, this sheet-like gel was stripped off from the stainless steel plate and then cut thinly into pieces of 6.5 mm in width to prepare noodle strings. These noodle strings were dried at 90° C. for 10 minutes, then placed in a retainer and dried by blowing a hot-air of 90° C. on the noodle strings for 20 minutes to give noodle masses.

The resulting noodle masses were reconstituted with water at 20° C. for 5 minutes. At this time, the noodle masses changed their weight from 1.26 g before reconstitution with water to 35.71 g, to show 2830% water absorption.

### Example 25

3.74 g of carrageenin (trade name: Purified Carrageenan, manufactured by CP Kelco) and 0.1 g of curdlan (trade name: Curdlan NS, manufactured by Kirin Food-Tech Company, Limited) were dispersed in 300 mL of water and then heated to 70° C. under stirring, thereby preparing a sol containing carrageenin and curdlan at a total concentration of 1.3% by weight. This sol was applied to a thickness of 1.5 mm on a stainless steel plate and gelatinized by cooling at 5° C. for 10 minutes to form a sheet-like gel. Then, this sheet-like gel was stripped off from the stainless steel plate and then cut thinly into pieces of 6.5 mm in width to prepare noodle strings. These noodle strings were dried at 90° C. for 10 minutes, then placed in a retainer and dried by blowing a hot-air of 90° C. on the noodle strings for 20 minutes to give noodle masses.

The resulting noodle masses were reconstituted with water at 20° C. for 5 minutes. At this time, the noodle masses changed their weight from 1.36 g before reconstitution with water to 25.81 g, to show 1900% water absorption.

### Comparative Example 3

3.84 g of carrageenin (trade name: Purified Carrageenan, manufactured by CP Kelco) only was dispersed in 70 mL of water and then heated to 70° C. thereby preparing a sol. This sol was applied to a thickness of 1.5 mm on a 100-mesh stainless steel mesh and gelatinized by steaming for 5 minutes to form a sheet-like gel. Then, this sheet-like gel was stripped off from the stainless steel mesh and then cut thinly into pieces of 6.5 mm in width to prepare noodle strings. These noodle strings were dried at 90° C. for 13 minutes, then placed in a retainer and dried by blowing a hot-air of 90° C. on the noodle strings for 20 minutes to give noodle masses.

The resulting noodle masses were reconstituted with water at 20° C. for 5 minutes. At this time, the noodle masses changed their weight from 2.11 g before reconstitution with water to 32.63 g, to show 1550% water absorption.

### Comparative Example 4

3.3 g of curdlan (trade name: Curdlan NS, manufactured by Kirin Food-Tech Company, Limited) only was dispersed in 70 mL of water and then heated to 50° C. thereby preparing a sol. This sol was applied to a thickness of 1.5 mm on a 100-mesh stainless steel mesh and gelatinized by steaming for 5 minutes to form a sheet-like gel. Then, this sheet-like gel was stripped off from the stainless steel mesh and then cut thinly into pieces of 6.5 mm in width to prepare noodle strings. These noodle strings were dried at 90° C. for 13 minutes, then placed in a retainer and dried by blowing a hot-air of 90° C. on the noodle strings for 20 minutes to give noodle masses.

The resulting noodle masses were reconstituted with water at 20° C. for 5 minutes. At this time, the noodle masses changed their weight from 4.26 g before reconstitution with water to 15.56 g, to show 370% water absorption.

After 200 mL of water at 20° C. was poured onto each noodle mass obtained in Examples 14 to 25 and Comparative Examples 3 and 4, the noodle masses were reconstituted with water for exactly 5 minutes, then eaten by a panel of 7 judges, thereby comprehensively evaluating their texture, hardness, feeling upon swallowing, and taste, and finally judged as “A” (very good), “B” (good) or “C” (bad). The results are shown in Table 2 below. In Table 2, the raw material composition, sol concentration and water absorption are shown.

TABLE 2

| | Raw material | | Sol | | Compre- |
|---|---|---|---|---|---|
| | composition | | concen- | Water | hensive |
| | (weight ratio) | | tration | absorp- | evalua- |
| | Carrageenin | Curdlan | (wt %) | tion (%) | tion |
| Example 14 | 3 | 97 | 4.6 | 480 | B |
| Example 15 | 3 | 97 | 2.2 | 770 | A |
| Example 16 | 14 | 86 | 7.1 | 650 | B |
| Example 17 | 14 | 86 | 5.2 | 600 | B |
| Example 18 | 14 | 86 | 2.5 | 1150 | A |
| Example 19 | 31 | 69 | 5.2 | 710 | A |
| Example 20 | 35 | 65 | 5.2 | 560 | A |
| Example 21 | 39 | 61 | 5.2 | 780 | B |
| Example 22 | 74 | 26 | 5.2 | 980 | B |
| Example 23 | 97 | 3 | 5.2 | 1330 | B |
| Example 24 | 97 | 3 | 1.5 | 2830 | A |
| Example 25 | 97 | 3 | 1.3 | 1900 | B |
| Comparative | 100 | — | 5.2 | 1550 | C |
| Example 3 | | | | | |
| Comparative | — | 100 | 4.5 | 370 | C |
| Example 4 | | | | | |

As is evident from Table 2 above, it can be seen that the instant noodles consisting of carrageenin and curdlan in Examples 14 to 25 can be reconstituted in 5 minutes with water at 20° C. and are excellent in comprehensive evaluation in eating after reconstitution with water, as compared with those in Comparative Examples 3 and 4. That is, it was revealed that instant noodles that can be eaten after a short time of 5 minutes and are excellent in texture and taste, which cannot be achieved by singly using carrageenin or curdlan, can be produced by combining carrageenin with curdlan as shown in the present invention.

### Example 26

0.75 g of agar (trade name: UM-11KS, manufactured by Ina Food Industry Co., Ltd.) and 4.5 g of hard wheat flour were dispersed in 70 mL of water and heated to 100° C. under stirring. 30 mL of water containing 2.25 g of curdlan (trade name: Curdlan NS, manufactured by Kirin Food-Tech Company, Limited) dispersed therein was added to the solution, followed by dropping the temperature to 60° C. under stirring, thereby preparing a sol containing agar and curdlan at a total concentration of 2.9% by weight. Then, this sol was applied to a thickness of 3.5 mm on an aluminum plate and gelatinized by leaving the plate on ice water for 10 minutes to form a gel. This gel was cut thinly into pieces of 3.0 mm in width to prepare noodle strings. These noodle strings were dried at 90° C. for 16 minutes, then placed in a retainer and dried by blowing a hot-air of 90° C. on the noodle strings for 30 minutes to give noodle masses.

The resulting noodle masses were reconstituted with water at 20° C. for 3 minutes. At this time, the noodle masses changed their weight from 5.46 g before reconstitution with water to 14.98 g, to show 270% water absorption.

### Example 27

0.3 g of agar (trade name: UM-11KS, manufactured by Ina Food Industry Co., Ltd.) and 4.5 g of hard wheat flour were dispersed in 60 mL of water and heated to 100° C. under stirring. 40 mL of water containing 2.7 g of curdlan (trade name: Curdlan NS, manufactured by Kirin Food-Tech Company, Limited) dispersed therein was added to the solution, followed by dropping the temperature to 60° C. under stirring, thereby preparing a sol containing agar and curdlan at a total concentration of 2.9% by weight. Then, this sol was applied to a thickness of 3.5 mm on an aluminum plate and gelatinized by leaving the plate on ice water for 10 minutes to form a gel. This gel was cut thinly into pieces of 3.0 mm in width to prepare noodle strings. These noodle strings were dried at 90° C. for 16 minutes, then placed in a retainer and dried by blowing a hot-air of 90° C. on the noodle strings for 30 minutes to give noodle masses.

The resulting noodle masses were reconstituted with water at 20° C. for 3 minutes. At this time, the noodle masses changed their weight from 5.01 g before reconstitution with water to 13.88 g, to show 280% water absorption.

### Example 28

2.25 g of agar (trade name: UM-11KS, manufactured by Ina Food Industry Co., Ltd.), 4.5 g of potato starch and 0.15 g of trehalose were dispersed in 130 mL of water and heated to a temperature of 100° C. under stirring. 20 mL of water containing 0.75 g of curdlan (trade name: Curdlan NS, manufactured by Kirin Food-Tech Company, Limited) dispersed therein was added to the solution, followed by dropping the temperature to 60° C. under stirring, thereby preparing a sol containing agar and curdlan at a total concentration of 2.0% by weight. Then, this sol was applied to a thickness of 3.5 mm on an aluminum plate and gelatinized by leaving the plate on ice water for 10 minutes to form a gel. This gel was dried at 90° C. for 45 minutes and cut thinly into pieces of 3.0 mm in width to prepare noodle strings. These noodle strings were placed in a retainer and dried by blowing a hot-air of 90° C. on the noodle strings for 30 minutes to give noodle masses.

The resulting noodle masses were reconstituted with water at 20° C. for 3 minutes. At this time, the noodle masses changed their weight from 5.71 g before reconstitution with water to 17.14 g, to show 300% water absorption.

### Example 29

2.25 g of agar (trade name: UM-11KS, manufactured by Ina Food Industry Co., Ltd.), 4.5 g of potato starch and 0.15 g of trehalose were dispersed in 130 mL of water and heated to a temperature of 100° C. under stirring. 20 mL of water containing 0.75 g of curdlan (trade name: Curdlan NS, manufactured by Kirin Food-Tech Company, Limited) dispersed therein was added to the solution, followed by dropping the temperature to 60° C. under stirring, thereby preparing a sol containing agar and curdlan at a total concentration of 2.0% by weight. Then, this sol was applied to a thickness of 5 mm on an aluminum plate and gelatinized by leaving the plate on ice water for 10 minutes to form a gel. This gel was dried at 90° C. for 60 minutes and cut thinly into pieces of 3.0 mm in width to prepare noodle strings. These noodle strings were placed in a retainer and dried by blowing a hot-air of 90° C. on the noodle strings for 30 minutes to give noodle masses.

The resulting noodle masses were reconstituted with water at 20° C. for 3 minutes. At this time, the noodle masses changed their weight from 5.40 g before reconstitution with water to 15.19 g, to show 280% water absorption.

### Example 30

0.15 g of agar (trade name: Ina Kanten Yamato, manufactured by Ina Food Industry Co., Ltd.) was dispersed in 70 mL of water, dissolved on a boiling water bath, and then cooled to about 50° C. 3.3 g of curdlan (trade name: Curdlan NS, manufactured by Kirin Food-Tech Company, Limited), 3.0 g of wheat flour, 0.15 g of trehalose, 0.2 g of potassium chloride, and 0.5 g of sodium glutamate were dispersed in the above solution and heated to 50° C. to prepare a sol containing agar and curdlan at a total concentration of 4.5% by weight. This sol was applied to a thickness of 1.5 mm on a 100-mesh stainless steel mesh and gelatinized by steaming for 5 minutes to form a gel. This gel was cut thinly into pieces of 6.5 mm in width to prepare noodle strings. These noodle strings were dried at 90° C. for 16 minutes, then placed in a retainer and dried by blowing a hot-air of 90° C. on the noodle strings for 20 minutes to give noodle masses.

The resulting noodle masses were reconstituted with water at 20° C. for 3 minutes. At this time, the noodle masses changed their weight from 5.22 g before reconstitution with water to 14.78 g, to show 280% water absorption.

### Example 31

0.15 g of agar (trade name: Ina Kanten Yamato, manufactured by Ina Food Industry Co., Ltd.) was dispersed in 70 mL of water, dissolved on a boiling water bath, and then cooled to about 50° C. 3.3 g of curdlan (trade name: Curdlan NS, manufactured by Kirin Food-Tech Company, Limited), 3.0 g of wheat flour, 0.1 g of trehalose, 0.2 g of potassium chloride, and 0.5 g of sodium glutamate were dispersed in the above solution and heated to 50° C. to prepare a sol containing agar and curdlan at a total concentration of 4.7% by weight. This sol was applied to a thickness of 1.5 mm on a 100-mesh stainless steel mesh and gelatinized by steaming for 5 minutes to form a gel. This gel was cut thinly into pieces of 2 mm in width to prepare noodle strings. These noodle strings were dried at 90° C. for 16 minutes, then placed in a retainer and dried by blowing a hot-air of 90° C. on the noodle strings for 20 minutes to give noodle masses.

The resulting noodle masses were reconstituted with water at 20° C. for 3 minutes. At this time, the noodle masses changed their weight from 4.15 g before reconstitution with water to 15.15 g, to show 370% water absorption.

After 200 mL of water at 20° C. was poured onto each noodle mass obtained in Examples 26 to 31, the noodle masses were reconstituted with water for exactly 3 minutes, then eaten by a panel of 7 judges, thereby comprehensively evaluating their texture, hardness, feeling upon swallowing, and taste, and finally judged as “A” (very good), “B” (good) or “C” (bad). The results are shown in Table 3 below. In Table 3, the raw material composition, sol concentration (concentration of agar and curdlan in the sol) and water absorption are shown.

TABLE 3

| | | | Sol | | Compre- |
|---|---|---|---|---|---|
| | Weight ratios of agar and | | concen- | Water | hensive |
| | curdlan in raw material | | tration | absorp- | evalua- |
| | Agar | Curdlan | (wt %) | tion (%) | tion |
| Example 26 | 25 | 75 | 2.9 | 270 | B |
| Example 27 | 10 | 90 | 2.9 | 280 | B |
| Example 28 | 75 | 25 | 2.0 | 300 | B |
| Example 29 | 75 | 25 | 2.3 | 280 | B |
| Example 30 | 4 | 96 | 4.7 | 280 | B |
| Example 31 | 4 | 96 | 4.7 | 370 | B |

As is evident from Table 3 above, it can be seen that the instant noodles containing agar and curdlan in Examples 26 to 31 can be reconstituted in 3 minutes with water at 20° C. and are excellent in comprehensive evaluation in eating after reconstitution with water. That is, it was revealed that instant noodles that can be eaten after a short time of 3 minutes and are excellent in texture and taste can be produced by combining agar with curdlan as shown in the present invention, even if wheat flour and seasonings are incorporated in predetermined or less ratios together with agar and curdlan.

### Example 32

3.96 g of curdlan (trade name: Curdlan NS, manufactured by Kirin Food-Tech Company, Limited), 0.648 g of carrageenin (trade name: Purified Carrageenan, manufactured by CP Kelco) and 3.6 g of wheat flour were dispersed in 70 mL of water and then heated to 50° C., thereby preparing a sol containing curdlan and carrageenin at a total concentration of 6.2% by weight. This sol was applied to a thickness of 1.5 mm on a 100-mesh stainless steel mesh and gelatinized by steaming for 5 minutes to form a gel. This gel was cut thinly into pieces of 6.5 mm in width to prepare noodle strings. These noodle strings were dried at 90° C. for 16 minutes, then placed in a retainer and dried by blowing a hot-air of 90° C. on the noodle strings for 20 minutes to give noodle masses.

The resulting noodle masses were reconstituted with water at 20° C. for 5 minutes. At this time, the noodle masses changed their weight from 4.99 g before reconstitution with water to 16.42 g, to show 330% water absorption.

### Example 33

3.63 g of curdlan (trade name: Curdlan NS, manufactured by Kirin Food-Tech Company, Limited), 0.594 g of carrageenin (trade name: Purified Carrageenan, manufactured by CP Kelco) and 3.3 g of wheat flour were dispersed in 70 mL of water and then heated to 50° C., thereby preparing a sol containing curdlan and carrageenin at a total concentration of 5.7% by weight. This sol was applied to a thickness of 1.5 mm on a 100-mesh stainless steel mesh and gelatinized by steaming for 5 minutes to form a gel. This gel was cut thinly into pieces of 6.5 mm in width to prepare noodle strings. These noodle strings were dried at 90° C. for 16 minutes, then placed in a retainer and dried by blowing a hot-air of 90° C. on the noodle strings for 20 minutes to give noodle masses.

The resulting noodle masses were reconstituted with water at 20° C. for 5 minutes. At this time, the noodle masses changed their weight from 4.06 g before reconstitution with water to 16.34 g, to show 400% water absorption.

### Example 34

3.3 g of curdlan (trade name: Curdlan NS, manufactured by Kirin Food-Tech Company, Limited), 0.54 g of carrageenin (trade name: Purified Carrageenan, manufactured by CP Kelco) and 0.96 g of wheat flour were dispersed in 70 mL of water and then heated to 50° C., thereby preparing a sol containing curdlan and carrageenin at a total concentration of 5.2% by weight. This sol was applied to a thickness of 1.5 mm on a 100-mesh stainless steel mesh and gelatinized by steaming for 5 minutes to form a gel. This gel was cut thinly into pieces of 6.5 mm in width to prepare noodle strings. These noodle strings were dried at 90° C. for 16 minutes, then placed in a retainer and dried by blowing a hot-air of 90° C. on the noodle strings for 20 minutes to give noodle masses.

The resulting noodle masses were reconstituted with water at 20° C. for 5 minutes. At this time, the noodle masses changed their weight from 4.03 g before reconstitution with water to 20.58 g, to show 510% water absorption.

After 200 mL of water at 20° C. was poured onto each noodle mass obtained in Examples 32 to 34, the noodle masses were reconstituted with water for exactly 5 minutes, then eaten by a panel of 7 judges, thereby comprehensively evaluating their texture, hardness, feeling upon swallowing, and taste, and finally judged as “A” (very good), “B” (good) or “C” (bad). The results are shown in Table 4 below. In Table 4, the raw material composition, sol concentration (concentration of carrageenin and curdlan in the sol) and water absorption are shown.

TABLE 4

| | Weight ratios of | | Sol | | Compre- |
|---|---|---|---|---|---|
| | carrageenin and curdlan | | concen- | Water | hensive |
| | in raw material | | tration | absorp- | evalua- |
| | Carrageenin | Curdlan | (wt %) | tion (%) | tion |
| Example 32 | 86 | 14 | 6.2 | 330 | B |
| Example 33 | 86 | 14 | 5.7 | 400 | B |
| Example 34 | 86 | 14 | 5.2 | 510 | A |

As is evident from Table 4 above, it can be seen that the instant noodles containing carrageenin and curdlan in Examples 32 to 34 can be reconstituted in 5 minutes with water at 20° C. and are excellent in comprehensive evaluation in eating after reconstitution with water. That is, it was revealed that instant noodles that can be eaten after a short time of 5 minutes and are excellent in texture and taste can be created by combining carrageenin with curdlan as shown in the present invention, even if wheat flour and seasonings are incorporated in predetermined or less ratios together with carrageenin and curdlan.

### Example 35

0.75 g of agar (trade name: UM-11S, manufactured by Ina Food Industry Co., Ltd.), 1.5 g of potato starch and 0.05 g of trehalose were added to 40 mL of water under stirring and dissolved by heating. When a homogeneous solution was obtained, a liquid containing 0.25 g of curdlan (trade name: Curdlan NS, manufactured by Kirin Food-Tech Company, Limited) dispersed in 10 mL of water was mixed therewith and immediately apply to a thickness of 1.0 mm on a stainless-steel tray, followed by cooling the tray by leaving it for 5 minutes, to prepare a sheet-like gel A1.

Then, a liquid containing 1.0 g of curdlan (trade name: Curdlan NS, manufactured by Kirin Food-Tech Company, Limited) and 0.25 g of pregelatinized tapioca starch dispersed in 50 mL of water was heated on a boiling water bath, and at a temperature of 60° C., the liquid was applied to a thickness of 1.0 mm on the sheet-like gel A1, followed by cooling the tray for minutes with cooling water (cooling medium), to prepare a sheet-like gel A2 having a 2-layer structure.

Then, 0.75 g of agar (trade name: UM-11S, manufactured by Ina Food Industry Co., Ltd.), 1.5 g of potato starch and 0.05 g of trehalose were added to mL of water and dissolved by heating. When a homogeneous solution was obtained, a liquid containing 0.25 g of curdlan (trade name: Curdlan NS, manufactured by Kirin Food-Tech Company, Limited) dispersed in 10 mL of water was mixed therewith and immediately apply to a thickness of 1.0 mm on the sheet-like gel A2 having a 2-layer structure, followed by cooling the tray for 10 minutes with cooling water (cooling medium), to prepare a sheet-like gel having a 3-layer structure. The resulting sheet-like gel was dried at 90° C. for 45 minutes and then cut into noodle strings of 3 mm in width. These noodle strings were placed in a retainer and dried with hot air at 90° C. for 20 minutes to give about 7 g of noodle masses.

The resulting noodle masses were reconstituted with water at 20° C. for 3 minutes. At this time, the noodle masses changed their weight from 7.0 g before reconstitution with water to 28.61 g, to show 409% water absorption.

### Example 36

0.75 g of agar (trade name: UM-11S, manufactured by Ina Food Industry Co., Ltd.), 1.5 g of potato starch and 0.05 g of trehalose were added to 40 mL of water under stirring and dissolved by heating. When a homogeneous solution was obtained, a liquid containing 0.25 g of curdlan (trade name: Curdlan NS, manufactured by Kirin Food-Tech Company, Limited) dispersed in 10 mL of water was mixed therewith and immediately apply to a thickness of 1.0 mm on a stainless-steel tray, followed by cooling the tray by leaving it for 5 minutes, to prepare a sheet-like gel B1.

Then, 0.5 g of agar (trade name: UM-11S, manufactured by Ina Food Industry Co., Ltd.) was added to 25 mL of water and dissolved by heating. This agar solution was kept at 60° C. A liquid containing 0.5 g of curdlan (trade name: Curdlan NS, manufactured by Kirin Food-Tech Company, Limited) dispersed in 25 mL of water was heated on a boiling water bath. When the temperature of the liquid became 50° C., the agar solution kept at 60° C. was added thereto and continued to be heated. Immediately after the temperature reached 60° C., the liquid was applied to a thickness of 1.0 mm on the sheet-like gel B1, followed by cooling the tray for 5 minutes with cooling water (cooling medium), to prepare a sheet-like gel B2 having a 2-layer structure.

Then, 0.75 g of agar (trade name: UM-11S, manufactured by Ina Food Industry Co., Ltd.), 1.5 g of potato starch and 0.05 g of trehalose were added to 40 mL of water under stirring and dissolved by heating. When a homogeneous solution was obtained, a liquid containing 0.25 g of curdlan (trade name: Curdlan NS, manufactured by Kirin Food-Tech Company, Limited) dispersed in 10 mL of water was mixed therewith and apply to a thickness of 1.0 mm on the sheet-like gel B2 having a 2-layer structure, followed by cooling the tray for 10 minutes with cooling water (cooling medium), to prepare a sheet-like gel having a 3-layer structure. The resulting sheet-like gel was dried at 90° C. for 45 minutes and then cut into noodle strings of 3 mm in width. These noodle strings were placed in a retainer and dried with hot air at 90° C. for 20 minutes to give about 7 g of noodle masses.

The resulting noodle masses were reconstituted with water at 20° C. for 3 minutes. At this time, the noodle masses changed their weight from 7.0 g before reconstitution with water to 29.04 g, to show 420% water absorption.

After 200 mL of water at 20° C. was poured onto each noodle mass obtained in Examples 35 and 36, the noodle masses were reconstituted with water for exactly 3 minutes, then eaten by a panel of 7 judges, thereby comprehensively evaluating their texture, hardness, feeling upon swallowing, and taste, and finally judged as “A” (very good), “B” (good) or “C” (bad). The results are shown in Table 5 below. In Table 5, the raw material composition, sol concentration (concentration of agar and curdlan in the sol) and water absorption are shown.

TABLE 5

| | | | Sol | | Compre- |
|---|---|---|---|---|---|
| | Weight ratios of agar and | | concen- | Water | hensive |
| | curdlan in raw material | | tration | absorp- | evalua- |
| | Agar | Curdlan | (wt %) | tion (%) | tion |
| Example 35 | 50 | 50 | 2.0 | 409 | A |
| Example 36 | 67 | 33 | 2.0 | 420 | B |

As is evident from Table 5 above, it can be seen that the instant noodles having a 3-layer structure, containing agar and curdlan, in Examples 35 and 36 can be reconstituted in 3 minutes with water at 20° C. and are excellent in comprehensive evaluation in eating after reconstitution with water.

### Example 37

0.30 g of agar (trade name: UM-11KS, manufactured by Ina Food Industry Co., Ltd.) was dispersed in 30 mL of water and dissolved in a boiling water bath and then gelatinized by cooling in a refrigerator at 4° C. Then, the gel was milled with a food mill (trade name: TML16, manufactured by TESCOM & Co., Ltd.) to give agar in sol form. Meanwhile, 1.8 g of curdlan (trade name: Curdlan NS, manufactured by Kirin Food-Tech Company, Limited), 4.9 g of wheat flour, 0.1 g of trehalose, 0.2 g of potassium chloride, and 0.5 g sodium glutamate were dispersed in 40 mL of water, and the agar in sol form was added thereto to prepare a sol. Then, this sol was applied to a thickness of 1.5 mm on a 100-mesh stainless steel mesh and gelatinized by steaming for 5 minutes to form a sheet-like gel. This sheet-like gel was cut thinly into pieces of 6 mm in width and 5 cm in length to prepare noodle strings. These noodle strings were dried at 90° C. for 20 minutes to give noodle masses.

The resulting noodle masses were reconstituted with water at 20° C. for 3 minutes. At this time, the noodle masses changed their weight from 4.05 g before reconstitution with water to 10.33 g, to show 255% water absorption.

After 200 mL of water at 20° C. was poured onto each noodle mass obtained in Examples 37, the noodle masses were reconstituted with water for exactly 3 minutes, then eaten by a panel of 7 judges, thereby comprehensively evaluating their texture, hardness, feeling upon swallowing, and taste, and finally judged as “A” (very good), “B” (good) or “C” (bad). As a result, the comprehensive evaluation was “A” (very good).

1. Instant noodles comprising agar and curdlan and having water absorption of 250% or more upon reconstitution with water at 20° C. for 3 minutes.

2. The instant noodles according to claim 1. characterized in that the agar and the curdlan are compounded in ratios of 1 to 90% by weight and 10 to 99% by weight, respectively.

3. The instant noodles according to claim 1, characterized in that further compounds a third component of at least one selected from wheat flour and starch.

4. The instant noodles according to claim 3, characterized in that the third component is incorporated in a ratio of 80% by weight or less based on the total amount of the agar and the curdlan.

5. The instant noodles according to claim 1, characterized in that each of the instant noodles has a multilayer structure in which outer layers contain the agar and the curdlan and an inner layer positioned between the outer layers has a composition which is different to that of the outer layers.

6. The instant noodles according to claim 5, characterized in that the inner layer comprises at least one component selected from the agar and the curdlan.

7. A method for producing instant noodles, characterized by comprising:
preparing a sol of raw material containing agar and curdlan;
preparing gelatinized noodle strings from the sol; and
drying the gelatinized noodle strings.

8. The method for producing instant noodles according to claim 7, characterized in that the total concentration of the agar and the curdlan in the sol is 0.2 to 6.0% by weight.

9. The method for producing instant noodles according to claim 7, characterized in that the agar and the curdlan are compounded in a ratio by weight from 1:99 to 90:10 in the sol.

10. The method for producing instant noodles according to claim 7, characterized in that the sol further comprises a third component of at least one selected from wheat flour and starch.

11. The method for producing instant noodles according to claim 10, characterized in that the third component is contained in a ratio of 80% by weight or less based on the total amount of the agar and the curdlan.

12. The method for producing instant noodles according to claim 7, characterized in that the gelatinized noodle strings prepared from the sol are manufactured by forming the sol into a sheet, then gelatinizing it to form a gelatinized noodle strip, and cutting the noodle strip thin.

13. The method for producing instant noodles according to claim 7, characterized in that the gelatinized noodle strings prepared from the sol are manufactured by discharging the sol directly in the form of thin strings and gelatinizing the strings.

14. The method for producing instant noodles according to claim 12 or 13, characterized in that the gelatinizing is performed by cooling.

15. The method for producing instant noodles according to claim 12 or 13, characterized in that the gelatinizing is performed by heating.

16. Instant noodles characterized by comprising carrageenin and curdlan and having water absorption of 300% or more upon reconstitution with water at 20° C. for 5 minutes.

17. The instant noodles according to claim 16, characterized in that the carrageenin and the curdlan are compounded in ratios of 2 to 98% by weight and 2 to 98% by weight, respectively.

18. The instant noodles according to claim 16, characterized in that further compounds a third component of at least one selected from wheat flour and starch.

19. The instant noodles according to claim 18, characterized in that the third component is incorporated in a ratio of 60% by weight or less based on the total amount of the carrageenin and the curdlan.

20. A method for producing instant noodles, characterized by comprising:
preparing a sol of raw material containing scarrageenin and curdlan;
preparing gelatinized noodle strings from the sol; and
drying the gelatinized noodle strings.

21. The method for producing instant noodles according to claim 20, characterized in that the carrageenin and the curdlan are contained in a ratio by weight from 2:98 to 98:2 in the sol.

22. The method for producing instant noodles according to claim 20, characterized in that the gelatinized noodle strings prepared from the sol are manufactured by forming the sol into a sheet, then gelatinizing it to form a gelatinized noodle strip, and cutting the noodle strip thin.

23. The method for producing instant noodles according to claim 20, characterized in that the gelatinized noodle strings prepared from the sol are manufactured by discharging the sol directly in the form of thin strings and gelatinizing the strings.

24. The method for producing instant noodles according to claim 22 or 23, characterized in that the gelatinizing is conducted by cooling.

25. The method for producing instant noodles according to claim 24, characterized in that the total concentration of the carrageenin and the curdlan in the sol to be gelatinized by cooling is 1.2 to 5.2% by weight.

26. The method for producing instant noodles according to claim 22 or 23, characterized in that the gelatinizing is performed by heating.

27. The method for producing instant noodles according to claim 26, characterized in that the total concentration of carrageenin and curdlan in the sol to be gelatinized by heating is 2.2 to 7.2% by weight.

28. The method for producing instant noodles according to claim 20, characterized in that the sol further comprises a third component of at least one selected from wheat flour and starch.

29. The method for producing instant noodles according to claim 28, characterized in that the third component is incorporated in a ratio of 60% by weight or less based on the total amount of the carrageenin and the curdlan.
